(19) United States
(12) Patent Application Publication
(10) Pub. No.: US 2024/0159591 A1
(43) Pub. Date: May 16, 2024

(54) ELECTROMAGNETIC WAVE SENSOR

(71) Applicant: TDK CORPORATION, Tokyo (JP)

(72) Inventors: Maiko KOKUBO, Tokyo (JP); Shinji HARA, Tokyo (JP); Naoki OHTA, Tokyo (JP); Susumu AOKI, Tokyo (JP); Kazuya MAEKAWA, Tokyo (JP); Tadao SENRIUCHI, Tokyo (JP); Yusuke KIMOTO, Tokyo (JP)

(73) Assignee: TDK CORPORATION, Tokyo (JP)

(21) Appl. No.: 18/384,630

(22) Filed: Oct. 27, 2023

(30) Foreign Application Priority Data
Nov. 11, 2022 (JP) 2022-180956

(51) Int. Cl. G01J 5/02

(52) U.S. Cl. CPC G01J 5/023; G01J 2005/202

(57) ABSTRACT

An electromagnetic wave sensor includes: a first wire which extends in a first direction; a second wire which extends in a second direction different from the first direction; and an electromagnetic wave detector which is electrically connected to the first wire and is electrically connected to the second wire, wherein the second wire is provided so as to leave an interval with respect to the first wire in a third direction orthogonal to the first direction and the second direction, and the second wire is disposed to three-dimensionally intersect the first wire. At least one wire of the first wire and the second wire includes a wide portion, which is wider than an average value of a width of a portion excluding an overlapping portion of the at least one wire, in the overlapping portion in which the first wire and the second wire overlap each other.

### CROSS-REFERENCE TO RELATED APPLICATION

Priority is claimed on Japanese Patent Application No. 2022-180956, filed Nov. 11, 2022, the content of which is incorporated herein by reference.

### BACKGROUND

The disclosure relates to an electromagnetic wave sensor.

For example, an electromagnetic wave sensor using an electromagnetic wave detector such as a thermistor element is known. The electrical resistance of a thermistor film of the thermistor element changes according to the temperature change of the thermistor film. In the electromagnetic wave sensor, infrared rays (electromagnetic waves) incident on the thermistor film are absorbed by the thermistor film or materials around the thermistor film, so that the temperature of the thermistor film changes. Accordingly, the thermistor element detects infrared rays.

Here, according to the Stefan-Boltzmann law, there is a correlation between the temperature of a measurement target and infrared rays (radiant heat) emitted from the measurement target by heat radiation. Thus, the temperature of the measurement target can be measured in a non-contact manner by detecting infrared rays emitted from the measurement target using the thermistor element.

Further, such thermistor elements are arranged in a two-dimensional array and are applied to electromagnetic wave sensors such as infrared imaging devices (infrared image sensors) that two-dimensionally detect (image) the temperature distribution of the measurement target (for example, see PCT International Publication No. WO 2019/171488).

### SUMMARY

Incidentally, in the above-described electromagnetic wave sensor, it is required to keep the electrical resistance value of the lead wire electrically connected to the thermistor element low in order to obtain good detection accuracy of infrared rays.

The electrical resistance value of the lead wire can be reduced by increasing the width of the lead wire, but if the width of the entire lead wire is simply increased, the area of the lead wire becomes large in a plan view. Accordingly, the detection accuracy of infrared rays may deteriorate.

For example, when the area of the lead wire becomes large in the plan view, the influence of the heat radiation from the lead wire to the thermistor element increases and the detection accuracy of infrared rays may deteriorate. Further, for example, when the area of the lead wire in the plan view increases, the influence of the lead wire shielding the thermistor element from infrared rays of the measurement target increases and the detection accuracy of infrared rays deteriorates.

It is desirable to provide an electromagnetic wave sensor capable of obtaining good detection accuracy of electromagnetic waves.

The disclosure provides the following means.

An electromagnetic wave sensor including:
a first wire which extends in a first direction;
a second wire which extends in a second direction different from the first direction; and
an electromagnetic wave detector which is electrically connected to the first wire and is electrically connected to the second wire,
wherein the second wire is provided so as to leave an interval with respect to the first wire in a third direction orthogonal to the first direction and the second direction, and the second wire is disposed to three-dimensionally intersect the first wire, and
wherein in a plan view from the third direction, at least one wire of the first wire and the second wire includes a wide portion, which is wider than an average value of a width of a portion excluding an overlapping portion of the at least one wire, in the overlapping portion in which the first wire and the second wire overlap each other.

### BRIEF DESCRIPTION OF THE DRAWINGS

FIG. 1 is a plan view illustrating a configuration of an electromagnetic wave sensor according to a first embodiment of the disclosure.

FIG. 2 is an exploded perspective view illustrating a configuration of the electromagnetic wave sensor illustrated in FIG. 1.

FIG. 3 is a plan view illustrating a configuration of the electromagnetic wave sensor illustrated in FIG. 1.

FIG. 4 is a plan view illustrating a configuration of a structure of the electromagnetic wave sensor illustrated in FIG. 3.

FIG. 5 is a cross-sectional view of the structure taken along line segment A1-A1 illustrated in FIG. 4.

FIG. 6 is a cross-sectional view of the structure taken along line segment B1-B1 illustrated in FIG. 4.

FIG. 7 is a plan view illustrating another configuration example of the electromagnetic wave sensor illustrated in FIG. 1.

FIG. 8 is a plan view illustrating another configuration example of the electromagnetic wave sensor illustrated in FIG. 1.

FIG. 9 is a plan view illustrating a configuration of an electromagnetic wave sensor according to a second embodiment of the disclosure.

FIG. 10 is a plan view illustrating a configuration of a structure of the electromagnetic wave sensor illustrated in FIG. 9.

FIG. 11 is a cross-sectional view of the structure taken along line segment A2-A2 illustrated in FIG. 10.

FIG. 12 is a cross-sectional view of the structure taken along line segment B2-B2 illustrated in FIG. 10.

FIG. 13 is a plan view illustrating another configuration example of the electromagnetic wave sensor illustrated in FIG. 9.

FIG. 14 is a plan view schematically illustrating a configuration of an electromagnetic wave sensor according to a third embodiment of the disclosure.

FIG. 15 is a cross-sectional view schematically illustrating a configuration of an electromagnetic wave sensor according to a fourth embodiment of the disclosure.

### DETAILED DESCRIPTION

Hereinafter, embodiments of the disclosure will be described in detail with reference to the drawings.

In addition, in the drawings used in the following description, in order to make each component easier to see, the scale of the dimensions may be changed depending on the component, and the dimensional ratio of each component may not necessarily be the same as the actual one. Further, the materials and the like provided in the following description are only exemplary examples, and the disclosure is not necessarily limited to them and can be implemented with appropriate modifications without changing the gist of the disclosure.

Further, in the drawings illustrated below, an XYZ orthogonal coordinate system is set, the X-axis direction is set as the first direction X within a specific plane of the electromagnetic wave sensor, the Y-axis direction is set as the second direction orthogonal to the first direction X within the specific plane of the electromagnetic wave sensor, and the Z-axis direction is set as the third direction Z orthogonal to the specific plane of the electromagnetic wave sensor. The third direction Z is a direction orthogonal to the first direction X and the second direction Y.

### First Embodiment

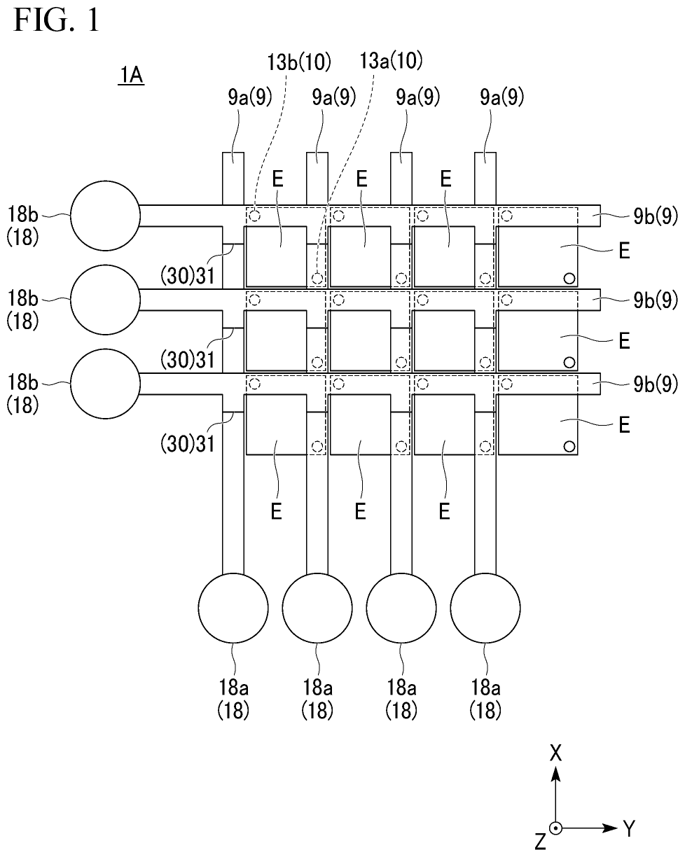

First, an electromagnetic wave sensor 1A, for example, illustrated in FIGS. 1 to 8 will be described as a first embodiment of the disclosure.

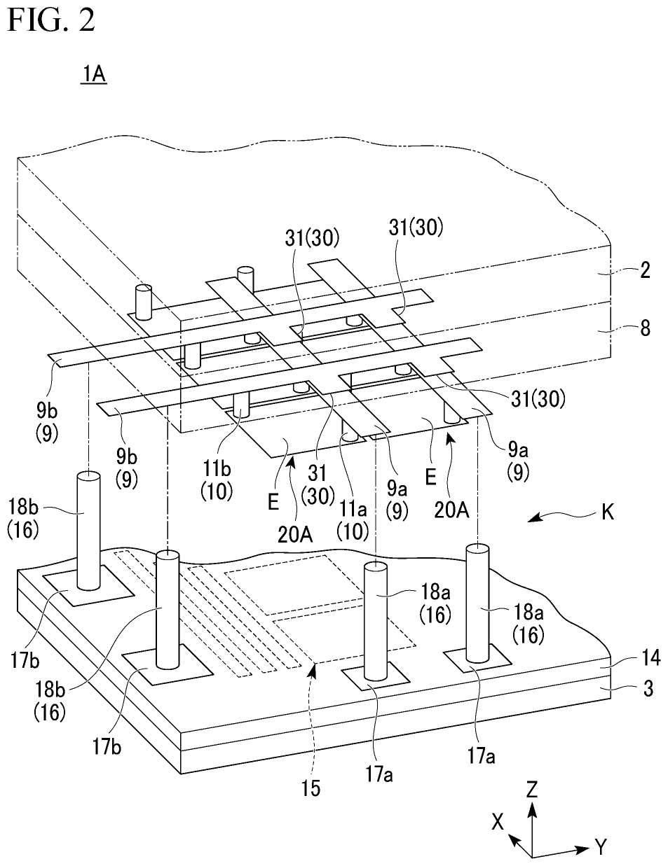

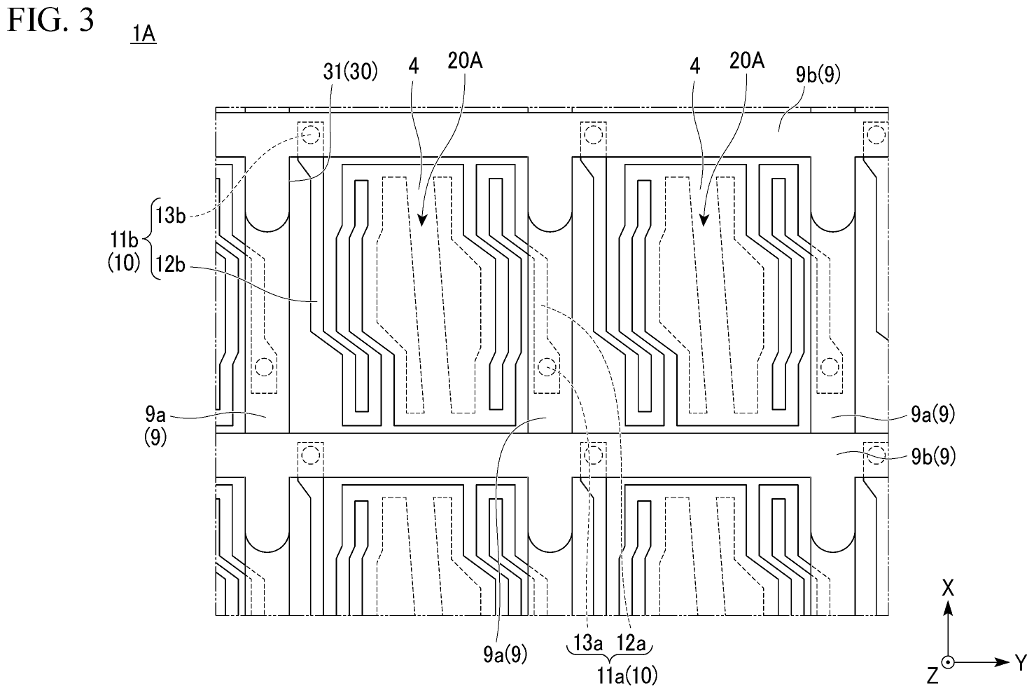

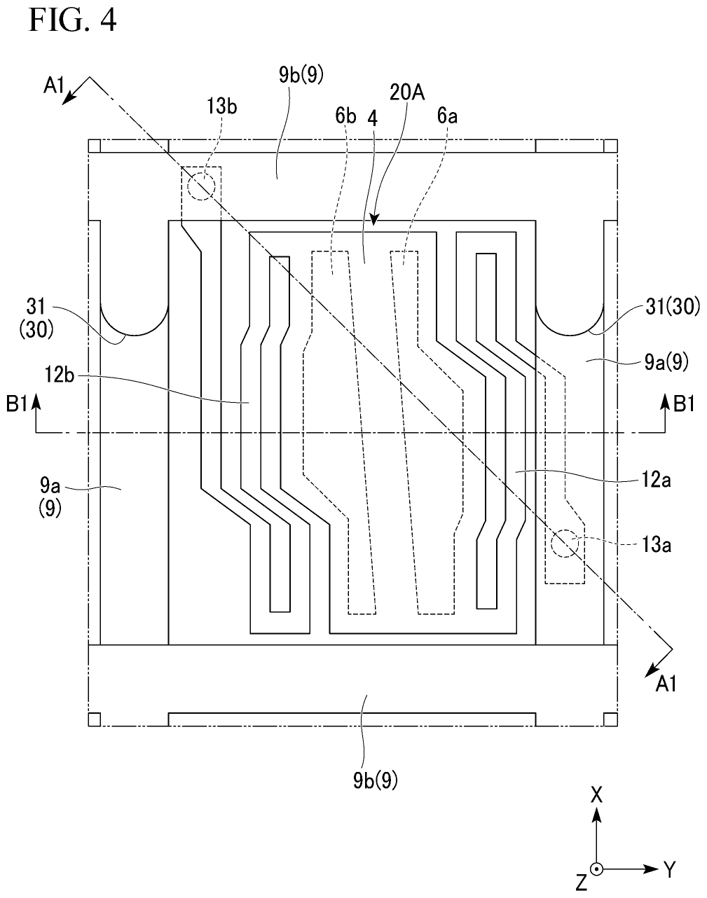

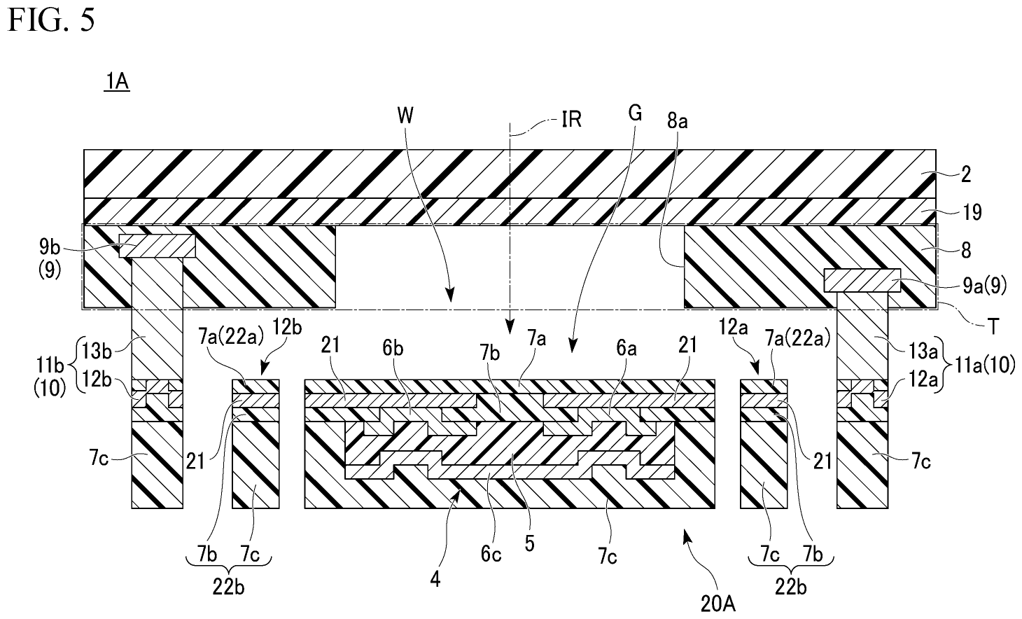

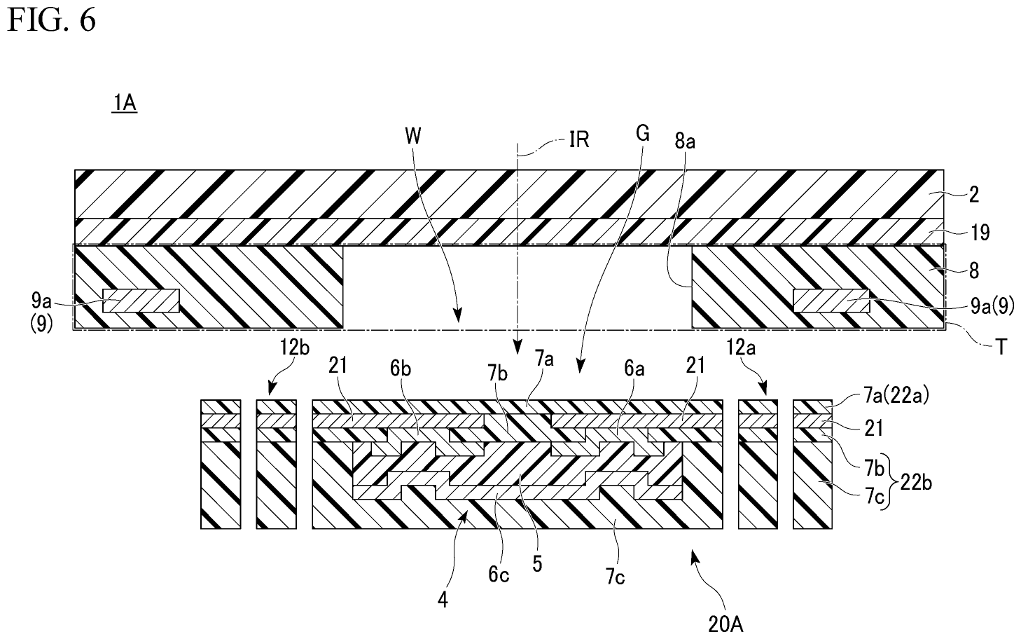

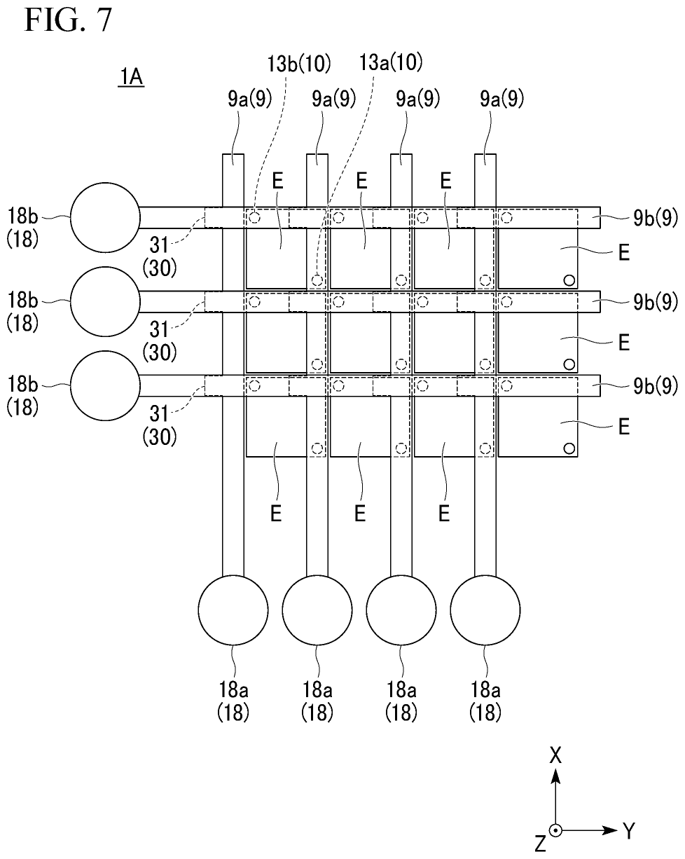

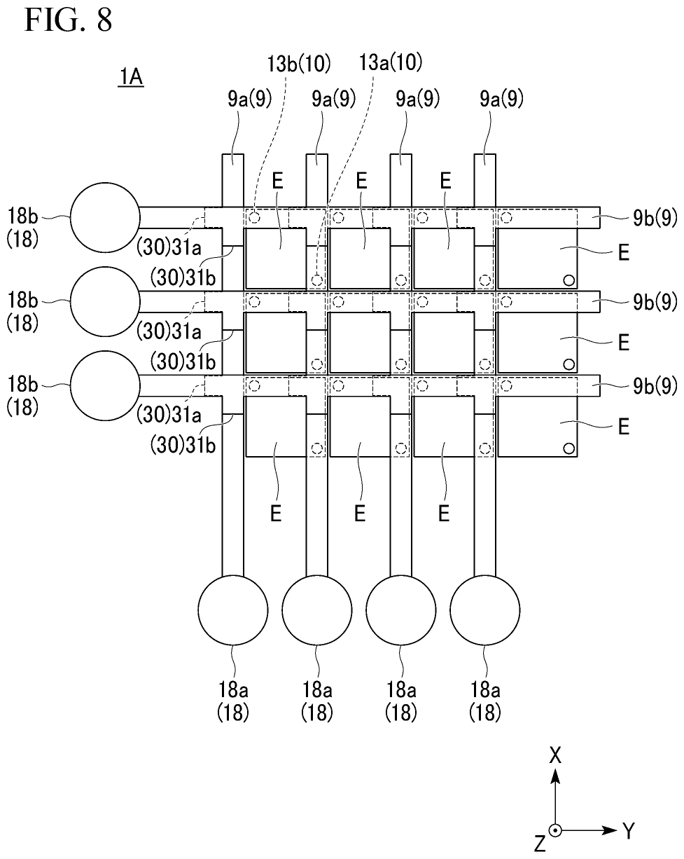

Additionally, FIG. 1 is a plan view illustrating a configuration of an electromagnetic wave sensor 1A. FIG. 2 is an exploded perspective view illustrating a configuration of the electromagnetic wave sensor 1A. FIG. 3 is a plan view illustrating a configuration of the electromagnetic wave sensor 1A. FIG. 4 is a plan view illustrating a configuration of a structure 20A of the electromagnetic wave sensor 1A. FIG. 5 is a cross-sectional view of the structure 20A taken along line segment A1-A1 illustrated in FIG. 4. FIG. 6 is a cross-sectional view of the structure 20A taken along line segment B1-B1 illustrated in FIG. 4. FIG. 7 is a plan view illustrating another configuration example of the electromagnetic wave sensor 1A. FIG. 8 is a plan view illustrating another configuration example of the electromagnetic wave sensor 1A.

The electromagnetic wave sensor 1A of this embodiment is obtained by applying the disclosure to an infrared imaging element (infrared image sensor) that two-dimensionally detects (images) the temperature distribution of the measurement target by detecting infrared rays emitted from the measurement target.

Infrared rays are electromagnetic waves with a wavelength of 0.75 μm or more and 1000 μm or less. Infrared image sensors are used as infrared cameras for indoor and outdoor night vision, and are also used as non-contact temperature sensors for measuring the temperature of people and objects.

Specifically, the electromagnetic wave sensor 1A includes, as illustrated in FIGS. 1 to 6, first and second substrates 2 and 3 which are arranged to face each other and thermistor elements 4 (not illustrated in FIGS. 1 and 2) which are arranged between the first substrate 2 and the second substrate 3.

The first substrate 2 and the second substrate 3 are silicon substrates having transparency with respect to electromagnetic waves of a certain wavelength, specifically, infrared rays IR having a wavelength band including a wavelength of 10 μm (in this embodiment, long wavelength infrared rays with wavelengths of 8 to 14 μm). Further, a germanium substrate or the like can be used as the substrate having transparency to infrared rays IR. The electromagnetic wave sensor 1A of this embodiment is configured such that electromagnetic waves which are emitted from the measurement target and will be detected (infrared rays IR emitted from the measurement target) are incident from the side of the first substrate 2.

The first substrate 2 and the second substrate 3 form an internal space K therebetween by sealing the periphery of the surfaces facing each other using a sealing material (not illustrated). Further, the internal space K is depressurized to a high vacuum.

Accordingly, in the electromagnetic wave sensor 1A of this embodiment, the influence of heat due to convection in the internal space K is suppressed and the influence of heat other than infrared rays IR emitted from the measurement target with respect to a thermistor element 4 is eliminated.

Additionally, the electromagnetic wave sensor 1A of this embodiment is not necessarily limited to a configuration in which the sealed internal space K is depressurized and may be configured to have the internal space K sealed or open under atmospheric pressure.

The thermistor element 4 is an electromagnetic wave detector which detects infrared rays IR, includes a thermistor film 5 which is a temperature sensing element, a pair of first electrodes 6a and 6b which are provided in contact with one surface of the thermistor film 5, a second electrode 6c which is provided in contact with the other surface of the thermistor film 5, and insulating films 7a, 7b, and 7c which are electromagnetic wave absorbers covering at least a portion (entirely in this embodiment) of the thermistor film 5, and has a CPP (Current-Perpendicular-to-Plane) structure in which current flows in a direction orthogonal to the surface of the thermistor film 5. The insulating film 7b is provided on the side opposite to the side contacting the thermistor film 5 in the pair of first electrodes 6a and 6b.

That is, in the thermistor element 4, current can flow from the first electrode 6a to the second electrode 6c in a direction orthogonal to the surface of the thermistor film 5 and current can flow from the second electrode 6c to the first electrode 6b in a direction orthogonal to the surface of the thermistor film 5.

As the thermistor film 5, for example, vanadium oxide, amorphous silicon, polycrystalline silicon, spinel crystal structure oxide containing manganese, titanium oxide, yttrium-barium-copper oxide, or the like can be used.

As the first electrodes 6a and 6b and the second electrode 6c, for example, a conductive film of platinum (Pt), gold (Au), palladium (Pd), ruthenium (Ru), silver (Ag), rhodium (Rh), iridium (Ir), osmium (Os), or the like can be used.

As the insulating films 7a, 7b, and 7c, for example, aluminum nitride, silicon nitride, aluminum oxide, silicon oxide, magnesium oxide, tantalum oxide, niobium oxide, hafnium oxide, zirconium oxide, germanium oxide, yttrium oxide, tungsten oxide, bismuth oxide, calcium oxide, aluminum oxynitride, silicon oxynitride, magnesium aluminum oxide, silicon boride, boron nitride, sialon (oxynitride of silicon and aluminum), or the like can be used.

The insulating films 7a, 7b, and 7c may be provided to cover at least a part of the thermistor film 5. In this embodiment, the insulating films 7a, 7b, and 7c are provided to cover both surfaces of the thermistor film 5.

Additionally, the thermistor element 4 has the above-described CPP structure, but may have a CIP structure in which the second electrode 6c is omitted.

The thermistor elements 4 are formed with the same size as each other. Further, the thermistor elements 4 are arranged in a two-dimensional array in a plane parallel to the first substrate 2 and the second substrate 3 (hereinafter, referred to as a “specific plane”). That is, the thermistor elements 4 are arranged in a matrix in a first direction X and a second direction Y that intersect each other (orthogonally in this embodiment) within the specific plane. Additionally, the first direction X and the second direction Y do not necessarily have to be orthogonal within the specific plane.

Further, the thermistor elements 4 are arranged side by side at regular intervals in the first direction X and the second direction Y on the assumption that the first direction X is the row direction and the second direction Y is the column direction.

Additionally, the number of rows and columns of the thermistor elements 4 is, for example, 640 rows×480 columns, 1024 rows×768 columns, or the like, but the disclosure is not limited to the number of matrices. That is, the number of matrices can be changed as appropriate.

A first insulator layer 8, a wiring portion 9 which is electrically connected to a circuit portion 15 to be described later, and a first connection portion 10 which electrically connects each thermistor element 4 to the wiring portion 9 are provided on the side of the first substrate 2.

The first insulator layer 8 is an insulating film formed on one surface of the first substrate 2 (the surface facing the second substrate 3). As the insulating film, for example, aluminum nitride, silicon nitride, aluminum oxide, silicon oxide, magnesium oxide, tantalum oxide, niobium oxide, hafnium oxide, zirconium oxide, germanium oxide, yttrium oxide, tungsten oxide, bismuth oxide, calcium oxide, aluminum oxynitride, silicon oxynitride, magnesium aluminum oxide, silicon boride, boron nitride, sialon (oxynitride of silicon and aluminum), and the like can be used.

The wiring portion 9 includes first lead wires (first wires) 9a and second lead wires (second wires) 9b. Each of the first lead wires 9a and each of the second lead wires 9b are made of, for example, a conductive film of copper or gold.

The first lead wires 9a and the second lead wires 9b are arranged at different positions in the third direction Z to intersect three-dimensionally. Among these, the first lead wires 9a extend in the first direction X and are arranged side by side at regular intervals in the second direction Y. On the other hand, the second lead wires 9b extend in the second direction Y and are arranged side by side at regular intervals in the first direction X.

That is, each of the first lead wires 9a is provided so as to leave an interval with respect to each of the second lead wires 9b in the third direction Z, and each of the first lead wires 9a is disposed to three-dimensionally intersect each of the second lead wires 9b. Further, each of the second lead wires 9b is provided so as to leave an interval with respect to each of the first lead wires 9a in the third direction Z, and each of the second lead wires 9b is disposed to three-dimensionally intersect each of the first lead wires 9a. A part of the first insulator layer 8 is disposed in a portion sandwiched between the first lead wire 9a and the second lead wire 9b.

Additionally, in this embodiment, the first lead wire 9a and the second lead wire 9b are located within the layer of the first insulator layer 8, but at least the surface of at least one lead wire of the first lead wire 9a and the second lead wire 9b may be exposed from the first insulator layer 8.

Each thermistor element 4 is provided in each area E partitioned by the first lead wires 9a and the second lead wires 9b in a plan view in the third direction Z (hereinafter, simply referred to as “plan view”). A window portion W for transmitting infrared rays IR between the first substrate 2 and the thermistor film 5 exists in an area facing each thermistor film 5 and the first substrate 2 in the thickness direction (an overlapping area in the plan view).

The first connection portion 10 includes a pair of first connection members 11a and 11b which are provided to correspond to each of the thermistor elements 4. In the electromagnetic wave sensor 1A of this embodiment, each of the thermistor elements 4 is electrically connected to a corresponding one of the first lead wires 9a via the first connection member 11a and each of the thermistor elements 4 is electrically connected to the corresponding one of the second lead wires 9b via the first connection member 11a.

Further, the pair of first connection members 11a and 11b and one thermistor element 4 constitute one structure 20A. Additionally, specific illustration of the structure 20A is omitted in FIGS. 1 and 2.

The pair of first connection members 11a and 11b include a pair of arm portions 12a and 12b and a pair of leg portions 13a and 13b.

Each of the arm portions 12a and 12b has a linear shape. The arm portions 12a and 12b include a linear wiring layer 21 which is electrically connected to the thermistor film 5 of the thermistor element 4 and protection layers 22a and 22b which are partially arranged on both surfaces of the wiring layer 21. Each of the protection layers 22a and 22b has a linear shape that matches the shape of the wiring layer 21.

The wiring layer 21 of the arm portion 12a is electrically connected to the thermistor film 5 via the first electrode 6a. The wiring layer 21 of the arm portion 12b is electrically connected to the thermistor film 5 via the first electrode 6b. The wiring layer 21 is made of, for example, at least one selected from aluminum, gold, silver, copper, tungsten, titanium, tantalum, chromium, silicon, titanium nitride, tantalum nitride, chromium nitride, tungsten nitride, and zirconium nitride. If sufficient mechanical strength of the arm portions 12a and 12b can be obtained only by the wiring layer 21, the protection layers 22a and 22b may not be provided on both surfaces of the wiring layer 21.

The protection layers 22a and 22b are made of the insulating films 7a, 7b, and 7c covering the above-described thermistor film 5. Among these, the protection layer (hereinafter, referred to as a “first protection layer”) 22a disposed on one surface of the wiring layer 21 is composed of the insulating film 7a and the protection layer (hereinafter, referred to as a “second protection layer”) 22b disposed on the other surface of the wiring layer 21 is composed of the insulating films 7b and 7c.

The pair of arm portions 12a and 12b are located on both sides of the thermistor element 4 in the plan view in the third direction Z. Further, each of the arm portions 12a and 12b includes at least a portion which extends along the periphery of the thermistor element 4 and a portion which is connected to the thermistor element 4.

Specifically, the arm portions 12a and 12b of this embodiment have a structure in which portions (two portions in this embodiment) extending in the first direction X are arranged side by side in the second direction Y and one end and the other end adjacent to each other are folded back and connected through a portion extending in the second direction Y. Further, the pair of arm portions 12a and 12b are connected to the thermistor element 4 at positions sandwiching the thermistor element 4 through a portion extending in the second direction Y.

Each of the leg portions 13a and 13b is a contact plug electrically connected to the first lead wire 9a or the second lead wire 9b. Each of the leg portions 13a and 13b is made of a conductor pillar having a circular cross-section by plating with, for example, copper, gold, FeCoNi alloy, or NiFe alloy (permalloy). Each of the leg portions 13a and 13b extends in a direction including a component of the third direction Z (the third direction Z in this embodiment).

The first connection member 11a includes the arm portion 12a which is electrically connected to the first electrode 6a and the leg portion 13a which electrically connects the arm portion 12b and the first lead wire 9a and electrically connects the first electrode 6a and the first lead wire 9a. That is, the leg portion 13a is electrically connected to the first lead wire 9a and the thermistor element 4 (the thermistor film 5).

The first connection member 11b includes the arm portion 12b which is electrically connected to the first electrode 6b and the leg portion 13b which electrically connects the arm portion 12b and the second lead wire 9b and electrically connects the first electrode 6b and the second lead wire 9b. That is, the leg portion 13b is electrically connected to the second lead wire 9b and the thermistor element 4 (the thermistor film 5).

Accordingly, the thermistor element 4 is supported in a suspended state in the third direction Z by the pair of first connection members 11a and 11b located diagonally in its plane. Further, a space G is provided between the thermistor element 4 and the first insulator layer 8.

A second insulator layer 14, the circuit portion 15 which detects a change in voltage output from the thermistor element 4 and converts the voltage into a brightness temperature, and a second connection portion 16 which electrically connects each thermistor element 4 and the circuit portion 15 are provided on the side of the second substrate 3.

The second insulator layer 14 is an insulating film which is formed on one surface of the second substrate 3 (a surface facing the first substrate 2). As the insulating film, the same insulating film provided as an exemplary example of the first insulator layer 8 can be used.

The circuit portion 15 includes a readout integrated circuit (ROIC), a regulator, an A/D converter (Analog-to-Digital Converter), a multiplexer, and the like and is provided within the layer of the second insulator layer 14.

Further, connection terminals 17a corresponding to the first lead wires 9a and connection terminals 17b corresponding to the second lead wires 9b are provided on the surface of the second insulator layer 14. The connection terminals 17a and 17b are made of, for example, a conductive film of copper or gold.

The connection terminals 17a are located on one side in the first direction X in the area around the circuit portion 15 and are arranged side by side at regular intervals in the second direction Y. The connection terminals 17b are located on one side in the second direction Y in the area around the circuit portion 15 and are arranged side by side at regular intervals in the first direction X.

The second connection portion 16 includes second connection members 18a provided to correspond to the first lead wires 9a and second connection members 18b provided to correspond to the second lead wires 9b. The second connection members 18a and 18b are made of conductor pillars with a circular cross-section formed by plating with copper, gold, or the like. The second connection members 18a and 18b extend in a direction including a component of the third direction Z (the third direction Z in this embodiment).

The second connection member 18a electrically connects one end side of the first lead wire 9a and the connection terminal 17a. The second connection member 18b electrically connects one end side of the second lead wire 9b and the connection terminal 17b. Accordingly, the first lead wires 9a and the circuit portion 15 are electrically connected via the second connection member 18a and the connection terminal 17a. Further, the second lead wires 9b and the circuit portion 15 are electrically connected via the second connection member 18b and the connection terminal 17b.

An antireflection layer 19 is provided on the side of the surface facing the thermistor element 4 in the first substrate 2. In this embodiment, the antireflection layer 19 is provided between the first substrate 2 and the first insulator layer 8. At least a part of the antireflection layer 19 faces at least a part of the thermistor element 4. The antireflection layer 19 allows infrared rays IR transmitted through the first substrate 2 to efficiently enter the thermistor film 5 by preventing the infrared rays IR from being reflected at the interface between the first substrate 2 and the space G until the infrared rays IR emitted from the measurement target pass through the window portion W from the first substrate 2 and enter the thermistor film 5.

As the antireflection layer 19, for example, zinc sulfide, yttrium fluoride, chalcogenide glass, germanium, silicon, zinc selenide, gallium arsenide, and the like can be used.

Further, the antireflection layer 19 may have a configuration in which films with different refractive indices are alternately laminated and the reflectance of infrared rays IR is reduced by utilizing the interference of waves reflected by each layer. In this case, as the antireflection layer 19, in addition to the above materials, for example, a laminated film obtained by laminating an oxide film, a nitride film, a sulfide film, a fluoride film, a boride film, a bromide film, a chloride film, a selenide film, a Ge film, a diamond film, a chalcogenide film, a Si film, and the like can be used.

A hole portion 8a penetrating the first insulator layer 8 is provided at a portion facing the thermistor element 4 in the first insulator layer 8. In other words, the hole portion 8a penetrating the first insulator layer 8 is provided between the antireflection layer 19 and the thermistor element 4. The hole portion 8a is provided at a portion facing the thermistor element 4 in the layer T provided with the first insulator layer 8.

In the electromagnetic wave sensor 1A of this embodiment with the above-described configuration, infrared rays IR emitted from the measurement target pass through the window portion W from the first substrate 2 and enter the thermistor element 4.

In the thermistor element 4, the temperature of the thermistor film 5 changes when infrared rays IR entering the insulating films 7a, 7b, and 7c formed in the vicinity of the thermistor film 5 are absorbed by the insulating films 7a, 7b, and 7c and infrared rays IR entering the thermistor film 5 are absorbed by the thermistor film 5. Further, in the thermistor element 4, the electrical resistance of the thermistor film 5 changes with the temperature change of the thermistor film 5 and hence the output voltage between the pair of first electrodes 6a and 6b changes. In the electromagnetic wave sensor 1A of this embodiment, the thermistor element 4 functions as a bolometer element.

In the electromagnetic wave sensor 1A of this embodiment, when infrared rays IR emitted from the measurement target are two-dimensionally detected by the thermistor elements 4 and the electrical signal (voltage signal) output from each thermistor element 4 is converted into a brightness temperature, it is possible to two-dimensionally detect (image) the temperature distribution (temperature image) of the measurement target.

In the electromagnetic wave sensor 1A of this embodiment, a constant current is applied to the thermistor film 5 and a change in voltage output from the thermistor film 5 is detected with respect to the temperature change of the thermistor film 5. However, a configuration may be adopted in which a constant voltage is applied to the thermistor film 5 and a change in current flowing through the thermistor film 5 is detected with respect to the temperature change of the thermistor film 5 and is converted into a brightness temperature.

Incidentally, in the electromagnetic wave sensor 1A of this embodiment, at least one lead wire (the second lead wire 9b in this embodiment) of the first lead wire 9a and the second lead wire 9b includes a wide portion 31, which is wider than the average value of the width of a portion excluding an overlapping portion 30 of one lead wire (the second lead wire 9b), in the overlapping portion 30 of the first lead wire 9a and the second lead wire 9b in the plan view from the third direction Z as illustrated in FIG. 1.

That is, the wide portion 31 overlaps the other lead wire (the first lead wire 9a in this embodiment) in the plan view and protrudes toward one side in the width direction of one lead wire (the second lead wire 9b) in the plan view.

In the configuration illustrated in FIG. 1, the wide portion 31 protrudes in the width direction with respect to a portion excluding the overlapping portion 30 of one lead wire (the second lead wire 9b). Additionally, in the example illustrated in FIG. 1, the width direction of the lead wire is a direction perpendicular to the extension direction of the lead wire in the plan view. That is, in the example illustrated in FIG. 1, the width of the wide portion 31 in the first direction X is wider than the average value of the width of the first direction X in a portion excluding the overlapping portion 30 of the second lead wire 9b extending in the second direction Y. In the example illustrated in FIG. 1, the range of the wide portion 31 is the same as the range of the overlapping portion 30 of the second lead wire 9b.

Further, the wide portion 31 may be formed over the outside of the overlapping portion 30 in the plan view instead of the range in which one lead wire (the second lead wire 9b) overlaps the other lead wire (the first lead wire 9a) in the plan view (the range of the overlapping portion 30). The wide portion 31 preferably does not overlap the electromagnetic wave detector (the thermistor element 4) in the plan view.

Further, the wide portion 31 may protrude toward both sides of the width direction of one lead wire (the second lead wire 9b) in the plan view. Further, the shape of the wide portion 31 is also not particularly limited and the shape can be changed as appropriate.

In the electromagnetic wave sensor 1A of this embodiment, since such a wide portion 31 is provided in the overlapping portion 30, it is possible to widen the width of one lead wire (the second lead wire 9b) in the wide portion 31 while suppressing an increase in the area of the lead wire in the plan view (the area including the first lead wire 9a and the second lead wire 9b in the plan view). Accordingly, it is possible to reduce the electrical resistance value of one lead wire (the second lead wire 9b) while suppressing an increase in heat radiation from the lead wires 9a and 9b, which become a heat source when energized, to the electromagnetic wave detector (the thermistor element 4).

Further, in the electromagnetic wave sensor 1A of this embodiment, since the first lead wire 9a and the second lead wire 9b are arranged on the incident direction side of electromagnetic waves (infrared rays IR) of the measurement target when viewed from the electromagnetic wave detector (thermistor element 4), it is conceived that a part of electromagnetic waves of the measurement target incident toward the electromagnetic wave detector (thermistor element 4) is shielded by the overlapping portion with the electromagnetic wave detector (thermistor element 4) in the plan view of the first lead wire 9a and the second lead wire 9b.

In the electromagnetic wave sensor 1A of this embodiment, it is possible to widen the width of one lead wire (second lead wire 9b) with respect to the wide portion 31 while suppressing an increase in the range in which the first lead wire 9a and the second lead wire 9b overlap the electromagnetic wave detector (thermistor element 4) in the plan view. Accordingly, it is possible to reduce the electrical resistance value of one lead wire (second lead wire 9b) while suppressing an increase in the influence of shielding the electromagnetic waves of the measurement target by the lead wires 9a and 9b.

Thus, in the electromagnetic wave sensor 1A of this embodiment, it is possible to obtain good detection accuracy of electromagnetic waves (infrared rays IR).

Additionally, in the electromagnetic wave sensor 1A, the wide portion 31 is provided in the second lead wire 9b of the first lead wire 9a and the second lead wire 9b, for example, as illustrated in FIG. 7, the wide portion 31 may be provided in the first lead wire 9a. Further, specific illustration of the structure 20A is omitted in FIG. 7.

Specifically, in the configuration illustrated in FIG. 7, the wide portion 31, which is wider than the average value of the width of a portion excluding the overlapping portion 30 of the first lead wire 9a, in the overlapping portion 30 in the plan view from the third direction Z is provided on the side of the first lead wire 9a.

In the configuration illustrated in FIG. 7, the wide portion 31 protrudes in the width direction in a portion excluding the overlapping portion 30 of the first lead wire 9a. Further, in the example illustrated in FIG. 7, the width direction of the lead wire is a direction perpendicular to the extension direction of the lead wire in the plan view. In the example illustrated in FIG. 7, the width of the wide portion 31 in the second direction Y is wider than the average value of the width of the second direction Y in a portion excluding the overlapping portion 30 of the first lead wire 9a extending in the first direction X. In the example illustrated in FIG. 7, the range of the wide portion 31 is the same as the range of the overlapping portion 30 of the first lead wire 9a.

That is, the wide portion 31 overlaps the second lead wire 9b in the plan view and protrudes toward one side of the width direction of the first lead wire 9a in the plan view. The wide portion 31 may protrude toward both sides of the width direction of the first lead wire 9a in the plan view.

Further, in the electromagnetic wave sensor 1A, for example, as illustrated in FIG. 8, a first wide portion 31a may be provided in the first lead wire 9a and a second wide portion 31b may be provided in the second lead wire 9b. Additionally, specific illustration of the structure 20A is omitted in FIG. 8.

Specifically, in the configuration illustrated in FIG. 8, the first wide portion 31a, which is wider than the average value of the width in a portion excluding the overlapping portion 30 of the first lead wire 9a, in the overlapping portion 30 in the plan view from the third direction Z is provided in the first lead wire 9a and the second wide portion 31b, which is wider than the average value of the width in a portion excluding the overlapping portion 30 of the second lead wire 9b, is provided in the second lead wire 9b.

That is, the first wide portion 31a overlaps the second lead wire 9b in the plan view and protrudes toward one side of the width direction of the first lead wire 9a in the plan view. The first wide portion 31a may protrude toward both sides of the width direction of the first lead wire 9a in the plan view.

The second wide portion 31b overlaps the first lead wire 9a in the plan view and protrudes toward one side of the width direction of the second lead wire 9b in the plan view. The second wide portion 31b may protrude toward both sides of the width direction of the second lead wire 9b in the plan view.

In the configuration of the electromagnetic wave sensor 1A illustrated in FIG. 8, it is possible to reduce the electrical resistance values of both wires (the first lead wire 9a and the second lead wire 9b) while suppressing an increase in heat radiation from the lead wires 9a and 9b, which become a heat source when energized, to the electromagnetic wave detector (the thermistor element 4). Further, in the configuration of the electromagnetic wave sensor 1A illustrated in FIG. 8, it is possible to reduce the electrical resistance values of both wires (the first lead wire 9a and the second lead wire 9b) while suppressing an increase in the influence of shielding the electromagnetic waves of the measurement target by the lead wires 9a and 9b.

### Second Embodiment

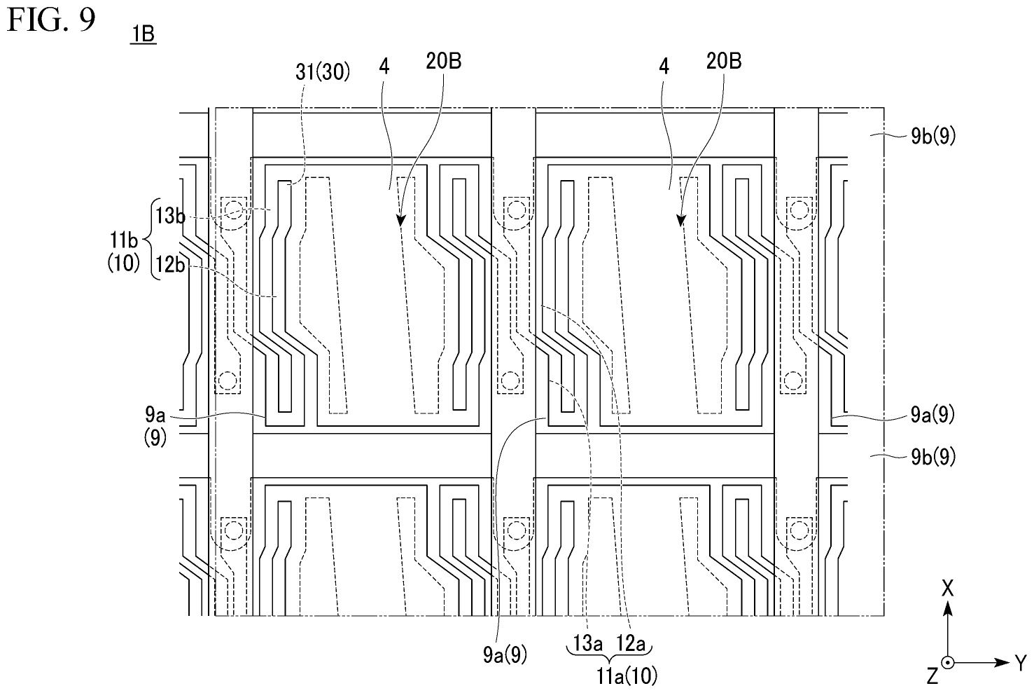

Next, an electromagnetic wave sensor 1B, for example, illustrated in FIGS. 9 to 13 will be described as a second embodiment of the disclosure.

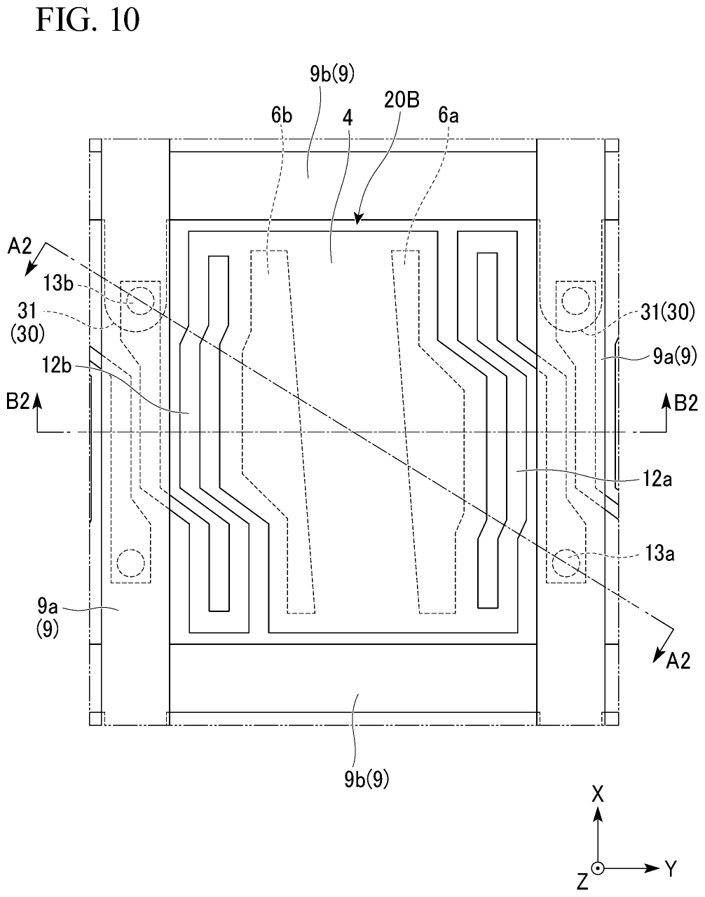

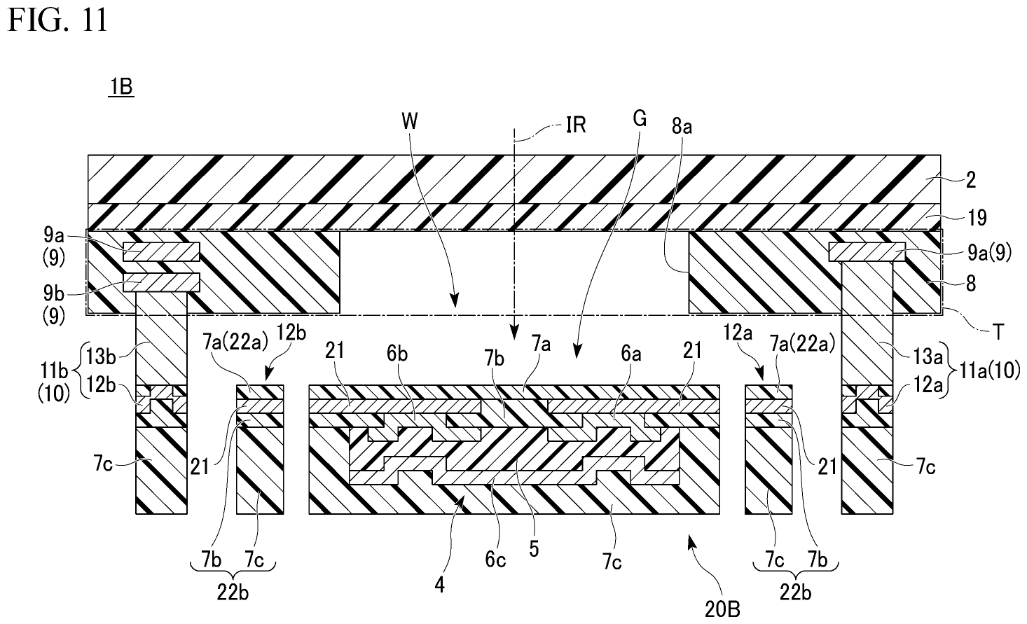

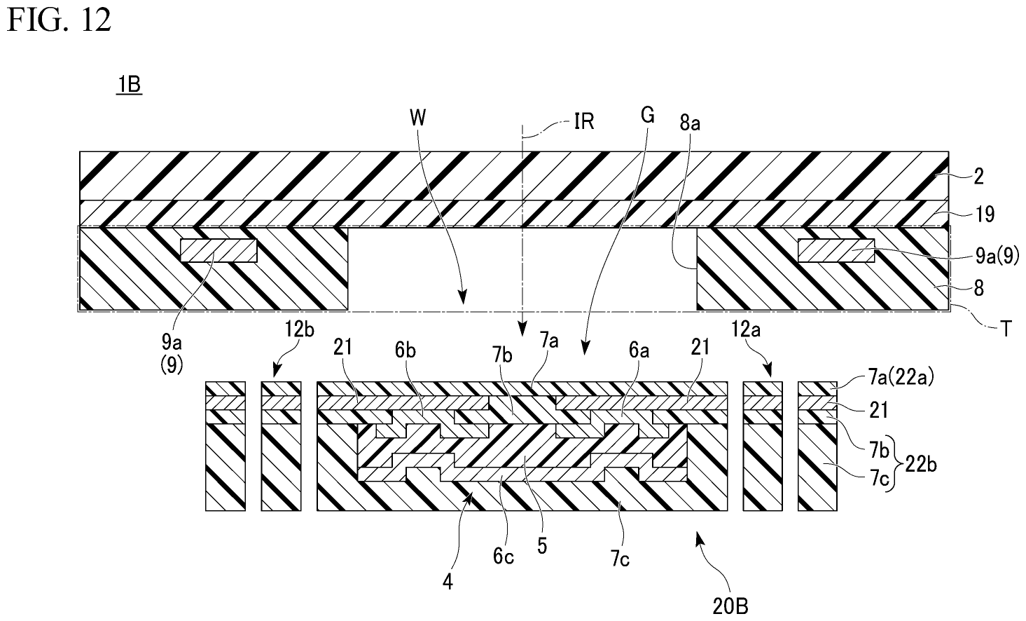

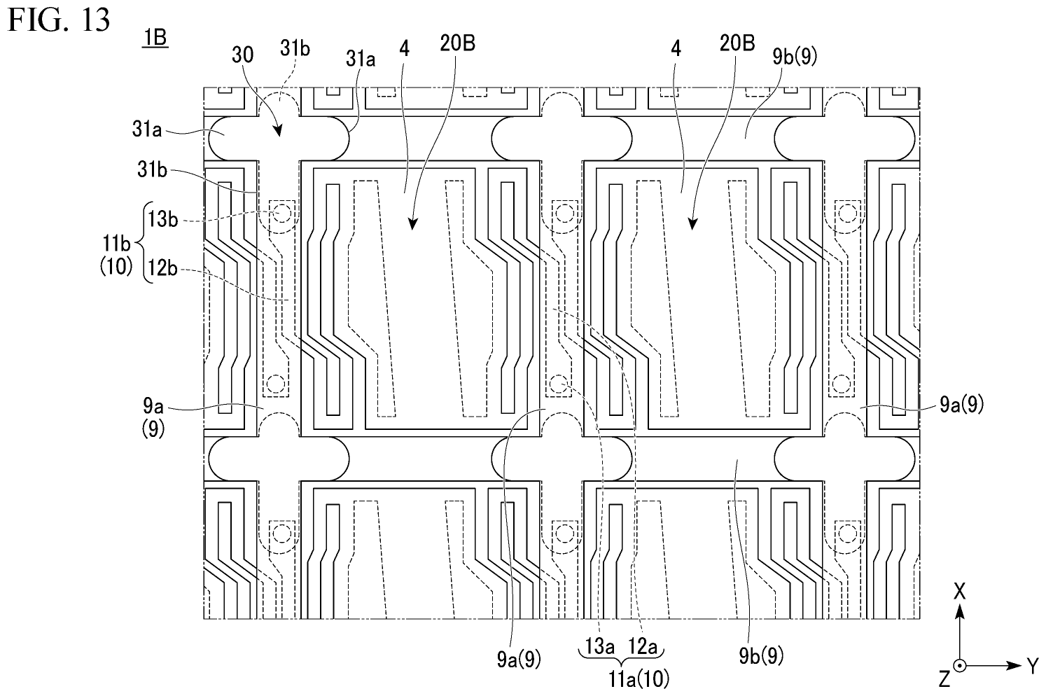

Additionally, FIG. 9 is a plan view illustrating a configuration of an electromagnetic wave sensor 1B. FIG. 10 is a plan view illustrating a configuration of a structure 20B of the electromagnetic wave sensor 1B. FIG. 11 is a cross-sectional view of the structure 20B taken along line segment A2-A2 illustrated in FIG. 10. FIG. 12 is a cross-sectional view of the structure 20B taken along line segment B2-B2 illustrated in FIG. 10. FIG. 13 is a plan view illustrating another configuration example of the electromagnetic wave sensor 1B. Further, in the following description, description of parts equivalent to those of the electromagnetic wave sensor 1A will be omitted and the same reference numerals will be given in the drawings.

The electromagnetic wave sensor 1B of this embodiment includes the structure 20B, for example, illustrated in FIGS. 9 to 12 instead of the structure 20A. Further, in the electromagnetic wave sensor 1B, the arrangement order of the first lead wire 9a and the second lead wire 9b is different from that in the electromagnetic wave sensor 1A. As for the other configurations, the electromagnetic wave sensor 1B basically has the same configuration as that of the electromagnetic wave sensor 1A.

Specifically, in the electromagnetic wave sensor 1B, each of the thermistor elements 4 is electrically connected to a corresponding one of the first lead wires 9a via the first connection member 11a and each of the thermistor elements 4 is electrically connected to the corresponding one of the second lead wires 9b via the first connection member 11a.

Further, the pair of first connection members 11a and 11b and one thermistor element 4 constitute one structure 20B.

Specifically, the structure 20B includes the pair of first connection members 11a and 11b including the pair of arm portions 12a and 12b and the pair of leg portions 13a and 13b and has a structure in which the thermistor element 4 is suspended from the first substrate 2 facing the thermistor element 4 through the pair of first connection members 11a and 11b.

Further, in the structure 20B, the pair of arm portions 12a and 12b are arranged point-symmetrically with respect to the center of the thermistor element 4 in the plan view. In the structure 20B, the connection position between the leg portion 13b and the second lead wire 9b is different from that of the structure 20A. As for the other configurations, the structure 20B basically has the same configuration as that of the structure 20A.

Further, in the electromagnetic wave sensor 1B, the second lead wire 9b is closer to the arm portions 12a and 12b in the third direction Z than the first lead wire 9a. That is, in the electromagnetic wave sensor 1B, the position of the second lead wire 9b in the third direction Z is located between the position of the first lead wire 9a in the third direction Z and the positions of the arm portions 12a and 12b in the third direction Z.

Incidentally, in the electromagnetic wave sensor 1B of this embodiment, as illustrated in FIG. 9, the wide portion 31 is provided in at least one lead wire (the second lead wire 9b in this embodiment) of the first lead wire 9a and the second lead wire 9b and one lead wire (the second lead wire 9b) is electrically connected to one end side of the leg portion 13b in the wide portion 31.

That is, the wide portion 31 overlaps the other lead wire (the first lead wire 9a in this embodiment) in the plan view and protrudes toward one side of the width direction of one lead wire (the second lead wire 9b) in the plan view. Further, the end portion of the wide portion 31 has a rounded shape in the plan view.

Additionally, in this embodiment, one lead wire (the second lead wire 9b) is electrically connected to one end side of the leg portion 13b in a portion protruding in the width direction in the wide portion 31. Further, in this embodiment, the wide portion 31 (a portion protruding in the width direction in the wide portion 31) is directly connected to one end side of the leg portion 13b.

Additionally, the wide portion 31 may be formed over the outside of the overlapping portion 30 in the plan view instead of the range in which one lead wire (the second lead wire 9b) overlaps the other lead wire (the first lead wire 9a) in the plan view (the range of the overlapping portion 30). Further, the wide portion 31 preferably does not overlap the electromagnetic wave detector (the thermistor element 4) in the plan view. Further, the wide portion 31 may protrude toward both sides of the width direction of one lead wire (the second lead wire 9b) in the plan view.

Further, the shape of the wide portion 31 is not necessarily limited to the shape in which the end portions of the wide portion 31 are rounded in the plan view, and the shape can be changed as appropriate.

In the electromagnetic wave sensor 1B of this embodiment, since such a wide portion 31 is provided in the overlapping portion 30, it is possible to obtain good detection accuracy of electromagnetic waves (infrared rays IR) similarly to the electromagnetic wave sensor 1A of the first embodiment.

Further, in the electromagnetic wave sensor 1B of this embodiment, one lead wire (the second lead wire 9b) is electrically connected to one end side of the leg portion 13b in the wide portion 31. Accordingly, it is possible to arrange the structures 20B with good space efficiency. Further, it is possible to form the arm portion 12a and the arm portion 12b with good symmetry. Furthermore, since the arm portions 12a and 12b formed with good symmetry are less likely to be distorted, high reliability of the electromagnetic wave sensor 1B can be obtained.

Additionally, in the electromagnetic wave sensor 1B, the wide portion 31 is provided in the second lead wire 9b of the first lead wire 9a and the second lead wire 9b and the second lead wire 9b is electrically connected to one end side of the leg portion 13b in the wide portion 31. However, for example, as illustrated in FIG. 13, the first wide portion 31a may be provided in the first lead wire 9a, the second wide portion 31b may be provided in the second lead wire 9b, and the second lead wire 9b may be electrically connected to one end side of the leg portion 13b in the second wide portion 31b.

That is, the first wide portion 31a overlaps the second lead wire 9b in the plan view and protrudes toward both sides of the width direction of the first lead wire 9a. The first wide portion 31a may protrude toward only one side of the width direction of the first lead wire 9a in the plan view.

The second wide portion 31b overlaps the first lead wire 9a in the plan view and protrudes toward both sides of the width direction of the second lead wire 9b. The second wide portion 31b may protrude toward only one side of the width direction of the second lead wire 9b in the plan view.

Additionally, in the example illustrated in FIG. 13, the second wide portion 31b is directly connected to one end side of the leg portion 13b. Further, in the example illustrated in FIG. 13, the second lead wire 9b is electrically connected to one end side of the leg portion 13b in the second wide portion 31b, but the first lead wire 9a may be electrically connected to one end side of the leg portion 13a in the first wide portion 31a. Further, both configurations may be provided.

### Third Embodiment

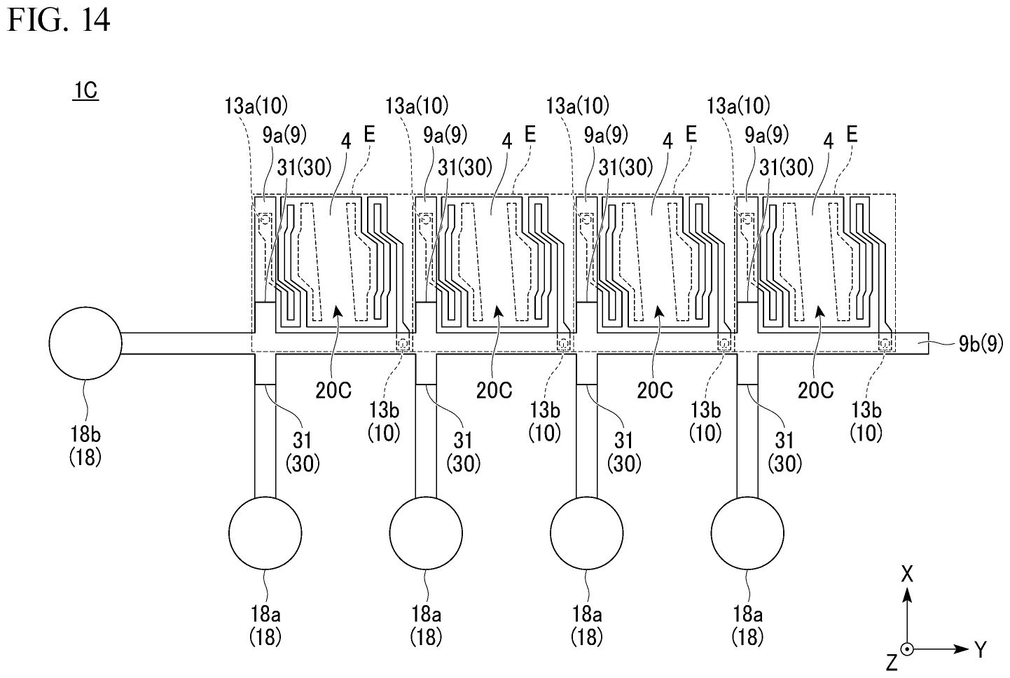

Next, an electromagnetic wave sensor 1C, for example, illustrated in FIG. 14 will be described as a third embodiment of the disclosure.

Additionally, FIG. 14 is a plan view schematically illustrating a configuration of the electromagnetic wave sensor 1C. Further, in the following description, description of parts equivalent to those of the electromagnetic wave sensors 1A and 1B will be omitted and the same reference numerals will be given in the drawings.

As illustrated in FIG. 14, the electromagnetic wave sensor 1C of this embodiment has a structure in which the thermistor elements 4 are arranged in a row.

That is, the electromagnetic wave sensor 1C includes one second lead wire 9b and the first lead wires 9a. Further, in the electromagnetic wave sensor 1C, the thermistor elements 4 are arranged side by side in the second direction Y. Further, the first lead wires 9a are arranged side by side in the second direction Y so that each of the thermistor elements 4 is electrically connected to a corresponding one of the first lead wires 9a. Further, each of the thermistor elements 4 is electrically connected to one second lead wire 9b.

The electromagnetic wave sensor 1C includes a structure 20C illustrated in FIG. 14 instead of the structure 20A of the electromagnetic wave sensor 1A. In the structure 20C, the shape of the arm portion is slightly different from the arm portions 12a and 12b of the structure 20A, but the other configurations are basically the same as those of the structure 20A.

Similarly to the electromagnetic wave sensor 1A of the first embodiment, in the electromagnetic wave sensor 1C illustrated in FIG. 14, at least one lead wire (the second lead wire 9b in this embodiment) of the first lead wire 9a and the second lead wire 9b includes the wide portion 31, which is wider than the average value of the width of a portion excluding the overlapping portion 30 of one lead wire (the second lead wire 9b), in the overlapping portion 30 in which the first lead wire 9a and the second lead wire 9b overlap each other in the plan view from the third direction Z.

That is, the wide portion 31 overlaps the other lead wire (the first lead wire 9a in this embodiment) in the plan view and protrudes toward both sides of the width direction of one lead wire (the second lead wire 9b) in the plan view.

Further, in the electromagnetic wave sensor 1C of this embodiment, the wide portion 31 may protrude toward one side of the width direction of the lead wire (the second lead wire 9b) in the plan view. Further, the electromagnetic wave sensor 1C may have a configuration in which the wide portion is provided in the first lead wire 9a similarly to the electromagnetic wave sensor 1A of the first embodiment. In this case, the wide portion provided in the first lead wire 9a may protrude toward both sides of the width direction of the first lead wire 9a in the plan view and may protrude toward one side of the width direction of the first lead wire 9a in the plan view.

Further, in the electromagnetic wave sensor 1C, the second lead wire 9b may be electrically connected to one end side of the leg portion 13b in the wide portion 31 similarly to the electromagnetic wave sensor 1B of the second embodiment.

In the electromagnetic wave sensor 1C of this embodiment, since the overlapping portion 30 including such a wide portion 31 is provided, it is possible to obtain good detection accuracy of electromagnetic waves (infrared rays IR) similarly to the electromagnetic wave sensor 1A of the first embodiment.

### Fourth Embodiment

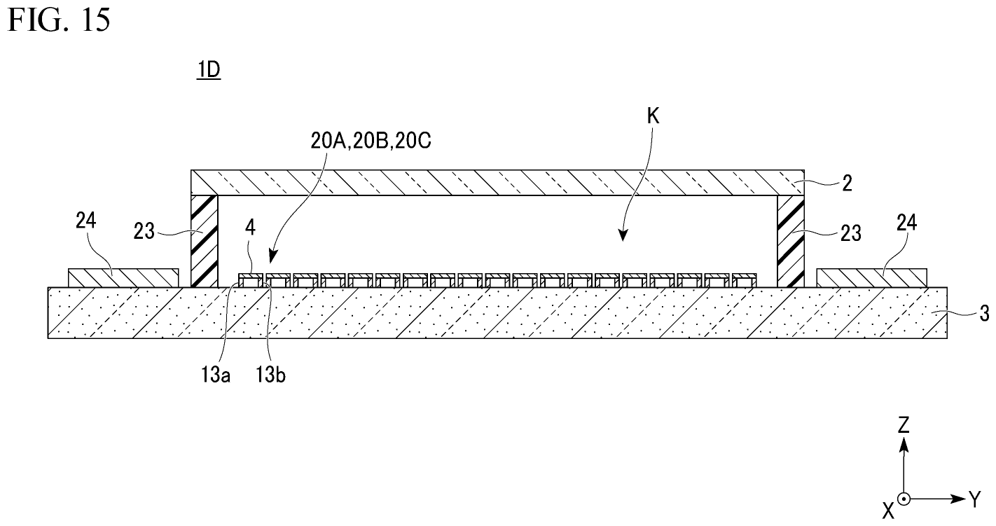

Next, an electromagnetic wave sensor 1D, for example, illustrated in FIG. 15 will be described as a fourth embodiment of the disclosure.

Additionally, FIG. 15 is a cross-sectional view schematically illustrating a configuration of the electromagnetic wave sensor 1D. For easy understanding, FIG. 15 is a schematic cross-sectional view combining cross-sections instead of one cross-section. Further, in the following description, description of parts equivalent to those of the electromagnetic wave sensors 1A, 1B, and 1C will be omitted and the same reference numerals will be given in the drawings.

As illustrated in FIG. 15, the electromagnetic wave sensor 1D of this embodiment has a structure in which the thermistor elements 4 are suspended from the second substrate 3 facing the thermistor element 4.

In this case, the wiring portion 9 is disposed on the side of the second substrate 3. That is, the first lead wire 9a and the second lead wire 9b are arranged at different positions in the third direction Z on the side of the second substrate 3 to intersect three-dimensionally.

Specifically, in the electromagnetic wave sensor 1D of this embodiment, the first lead wire 9a and the second lead wire 9b are located within the layer of the insulator layer formed on the second substrate 3 as in the case in which the first lead wire 9a and the second lead wire 9b are located within the layer of the first insulator layer 8 in the electromagnetic wave sensor 1A of the first embodiment. Further, a part of the insulator layer is disposed in a portion sandwiched between the first lead wire 9a and the second lead wire 9b.

Further, at least the surface of at least one lead wire of the first lead wire 9a and the second lead wire 9b may be exposed from the insulator layer formed on the second substrate 3. In this embodiment, the wiring portion 9 (the first lead wire 9a and the second lead wire 9b) constitutes a part of the readout integrated circuit (ROIC) provided in the second substrate 3. That is, the first connection members 11a and 11b are directly connected to the readout integrated circuit (ROIC) provided on the second substrate 3.

Further, in the electromagnetic wave sensor 1D of this embodiment, the thermistor elements 4 are arranged in the internal space K sealed by the first substrate 2, the seal member 23, and the second substrate 3. On the other hand, the electrode pad 24 electrically connected to the readout integrated circuit (ROIC) is disposed outside the internal space K.

Further, in the electromagnetic wave sensor 1D of this embodiment, it is possible to adopt the same configuration as the structures 20A, 20B, and 20C of the electromagnetic wave sensors 1A, 1B, and 1C as the structure including the first connection members 11a and 11b and one thermistor element 4.

Further, in the electromagnetic wave sensor 1D of this embodiment, it is possible to adopt the same configuration as the first lead wire 9a and the second lead wire 9b of the electromagnetic wave sensors 1A, 1B, and 1C as the first lead wire 9a and the second lead wire 9b.

That is, in the electromagnetic wave sensor 1D of this embodiment, at least one lead wire (for example, the second lead wire 9b) of the first lead wire 9a and the second lead wire 9b includes the wide portion 31, which is wider than the average value of the width of a portion excluding the overlapping portion 30 of one lead wire (for example, the second lead wire 9b), in the overlapping portion 30 in which the first lead wire 9a and the second lead wire 9b overlap each other in the plan view from the third direction Z similarly to the electromagnetic wave sensors 1A, 1B, and 1C.

Further, in the electromagnetic wave sensor 1D of this embodiment, the first lead wire 9a may include the wide portion 31 which is wider than the average value of the width of a portion excluding the overlapping portion 30 of the first lead wire 9a, in the overlapping portion 30, and the second lead wire 9b may include the wide portion 31, which is wider than the average value of the width of a portion excluding the overlapping portion 30 of the second lead wire 9b, in the overlapping portion 30 similarly to the electromagnetic wave sensors 1A, 1B, and 1C.

In the electromagnetic wave sensor 1D of this embodiment, since such a wide portion 31 is provided in the overlapping portion 30, it is possible to reduce the electrical resistance value of one lead wire (for example, the second lead wire 9b) or both wires (the first lead wire 9a and the second lead wire 9b) while suppressing an increase in heat radiation from the lead wires 9a and 9b, which become a heat source when energized, to the electromagnetic wave detector (the thermistor element 4) similarly to the electromagnetic wave sensor 1A of the first embodiment.

Thus, in the electromagnetic wave sensor 1D of this embodiment, it is possible to obtain good detection accuracy of electromagnetic waves (infrared rays IR).

Additionally, the disclosure is not necessarily limited to the above-described embodiments and can be modified into various forms in the scope not departing from the spirit of the disclosure.

For example, the electromagnetic wave sensor that adopts the disclosure is not necessarily limited to the configuration of the infrared image sensor in which the thermistor elements 4 are arranged two-dimensionally or linearly, but the disclosure can be also applied to the electromagnetic wave sensor or the like using one thermistor element 4.

Further, the electromagnetic wave sensor that adopts the disclosure is not necessarily limited to the one for detecting the infrared rays IR as electromagnetic waves, but the electromagnetic wave sensor may detect, for example, terahertz waves with a wavelength of 30 μm or more and 3 mm or less or visible light.

Further, the electromagnetic wave sensor that adopts the disclosure is not necessarily limited to the one that uses the thermistor element 4 as the electromagnetic wave detector and the one using a thermopile (thermocouple) type, pyroelectric type, or diode type temperature sensing element instead of the thermistor film 5 can be used as the electromagnetic wave detector. Instead of the thermistor element 4, an element such as a photodiode that directly detects electromagnetic waves can be used as the electromagnetic wave detector.

What is claimed is:

1. An electromagnetic wave sensor comprising:
a first wire which extends in a first direction;
a second wire which extends in a second direction different from the first direction; and
an electromagnetic wave detector which is electrically connected to the first wire and is electrically connected to the second wire,
wherein the second wire is provided so as to leave an interval with respect to the first wire in a third direction orthogonal to the first direction and the second direction, and the second wire is disposed to three-dimensionally intersect the first wire, and
wherein in a plan view from the third direction, at least one wire of the first wire and the second wire includes a wide portion, which is wider than an average value of a width of a portion excluding an overlapping portion of the at least one wire, in the overlapping portion in which the first wire and the second wire overlap each other.

2. The electromagnetic wave sensor according to claim 1,
wherein the wide portion protrudes toward one side of a width direction of the at least one wire in the plan view from the third direction.

3. The electromagnetic wave sensor according to claim 1,
Wherein the wide portion protrudes toward both sides of a width direction of the at least one wire in the plan view from the third direction.

4. The electromagnetic wave sensor according to claim 1, further comprising:
a leg portion which extends in a direction including at least a component of the third direction and is electrically connected to the at least one wire and the electromagnetic wave detector,
wherein the at least one wire is electrically connected to one end side of the leg portion at the wide portion.

5. The electromagnetic wave sensor according to claim 4, further comprising:
an arm portion which electrically connects an other end side of the leg portion and the electromagnetic wave detector.

6. The electromagnetic wave sensor according to claim 1,
wherein the electromagnetic wave detector comprises electromagnetic wave detectors,
wherein the at least one wire comprises wires, since the first wire comprises first wires or the second wire comprises second wires,
wherein the wires are provided side by side in the first direction or the second direction, so that each of the electromagnetic wave detectors is electrically connected to a corresponding one of the wires.

7. The electromagnetic wave sensor according to claim 1,
wherein the electromagnetic wave detector comprises electromagnetic wave detectors,
wherein the first wire comprises first wires,
wherein the second wire comprises second wires,
wherein the electromagnetic wave detectors are arranged in a two-dimensional array in the first direction and the second direction,
wherein the first wires are provided side by side in the second direction so that each of the electromagnetic wave detectors is electrically connected to a corresponding one of the first wires, and
wherein the second wires are provided side by side in the first direction so that each of the electromagnetic wave detectors is electrically connected to a corresponding one of the second wires.

8. The electromagnetic wave sensor according to claim 1,
wherein the electromagnetic wave detector includes a temperature sensing element and an electromagnetic wave absorber which covers at least a part of the temperature sensing element.
